(19) United States
(12) Patent Application Publication
(10) Pub. No.: US 2009/0266628 A1
(43) Pub. Date: Oct. 29, 2009

(54) Stair climbing tread hardware for a robot

(76) Inventors: Hagen Schempf, Pittsburgh, PA (US); Robert Fuchs, Munhall, PA (US); William Abraham Crowley, Pittsburgh, PA (US); Todd Graham, Pittsburgh, PA (US)

Correspondence Address: Iandiorio Teska & Coleman, 260 Bear Hill Road, Waltham, MA, 02451-1018, US

(21) Appl. No.: 12/383,883

(22) Filed: Mar. 30, 2009

Related U.S. Application Data
(60) Provisional application No. 61/125,372, filed on Apr. 24, 2008.

(51) Int. Cl. B62D 55/04; B62D 55/00; B62D 55/08

(52) U.S. Cl. 180/9.1

(57) ABSTRACT

An easily and quickly reconfigurable robot chassis with at least a pair of forward shafts and a pair of rearward shafts. A wheel is attachable to and removable from each drive shaft. A sprocket is also attachable to and removable from each shaft. A first pair of tracks each extend around opposing forward sprockets and rearward sprockets. A pair of forward track extenders are each removeably attachable to the chassis and each include a forward idler sprocket. A second pair of longer tracks each extend around opposing rearward sprockets, the forward sprockets, and forward idler sprockets. A pair of rearward track extenders are each removeably attachable to the chassis and each include a rearward idler sprocket. A third pair of still longer tracks each extend around opposing rearward idler sprockets, rearward sprockets, forward sprockets, and forward idler sprockets.

### RELATED APPLICATIONS

This application hereby claims the benefit of and priority to U.S. Provisional Application Ser. No. 61/125,372, filed on Apr. 24, 2008 under 35 U.S.C. §§119, 120, 363, 365, and 37 C.F.R. §1.55 and §1.78, incorporated by reference herein.

### FIELD OF THE INVENTION

The subject invention relates to robots and mobile vehicles.

### BACKGROUND OF THE INVENTION

There are numerous robots with specialized tracks configured to climb stairs and traverse obstacles. See, for example, U.S. Pat. No. 6,668,951 incorporated herein by this reference.

Wheeled robots are also popular. The robots provided by Automatika, Inc. (Pittsburg, Pa.) and Foster-Miller, Inc. (Waltham, Mass.) are examples. The applicant's “Dragon Runner” robot, for example, includes four driven wheels.

There are circumstances where it would be beneficial if a wheeled robot could be converted permanently or even just temporarily into a robot with tracks making the robot not only more terrainable, but also capable of climbing onto and over obstacles, including climbing and descending stairs. No known conversion system exists.

### BRIEF SUMMARY OF THE INVENTION

It is therefore an object of this invention to provide a method of converting a wheeled robot into a track driven robot.

It is a further object of this invention to provide a conversion system for converting a wheeled robot to a track driven robot.

The subject invention results from the realization that, in one embodiment, a wheeled robot can be made more versatile if the wheels are easily replaced by track sprockets, that easily added forward track extenders allow the track robot to more easily traverse curbs and other obstacles, and that easily added rearward track extenders along with the forward track extenders allow the robot to more easily climb stairs.

This subject invention features a reconfigurable robot comprising a chassis with at least a pair of forward shafts and a pair of rearward shafts. A wheel is attachable to and removable from each shaft. A sprocket is also attachable to and removable from each shaft. One set of tracks are each configured to extend around a forward sprocket and a rearward sprocket. In one preferred embodiment, a pair of forward track extenders are each removeably attachable to the chassis and each include a forward idler sprocket. A second pair of tracks are each configured to extend around a rearward sprocket, a forward sprocket, and a forward idler sprocket. A pair of rearward track extenders may also be provided, each removeably attachable to the chassis and each include a rearward idler sprocket. A third pair of tracks are each configured to extend around a rearward idler sprocket, a rearward sprocket, a forward sprocket, and a forward idler sprocket.

In one preferred embodiment, all the shafts are driven. A forward pair of removable sprocket adapters and a rearward pair of removable sprocket adapters may be provided. Each sprocket adapter typically includes a threaded portion and the robot further including a threaded nut securing a track extender to the threaded portion of the sprocket adapter. The sprocket adapters and the track extenders may include features locking the desired angle of the track extenders. The forward track extenders preferably extend at an angle upwardly or downwardly from the chassis and, typically, both the forward and rearward track extenders extend substantially beyond the robot chassis. In one design, the track extenders all include a tensioning mechanism. The wheels and the sprockets are typically each removeably locked to their respective shafts via a hex portion on each shaft, a hex orifice in each wheel and sprocket, and a clip secured through an orifice through each drive shaft.

The subject invention also features a reconfigurable robot comprising a chassis with at least a pair of forward shafts and a pair of rearward shafts; a wheel attachable to and removable from each forward shaft; a wheel attachable to and removable from each rearward shaft; a forward sprocket attachable to and removable from each forward shaft; a rearward sprocket each attachable to and removable from each rearward shaft; and a first pair of tracks each configured to extend around a forward sprocket and a rearward sprocket.

One reconfigurable robot includes a forward sprocket attachable to and removable from each forward shaft; a rearward sprocket attachable to and removable from each rearward shaft; a first pair of tracks each configured to extend around a forward sprocket and a rearward sprocket; a pair of forward track extenders each removeably attachable to the chassis and each including a forward idler sprocket; and a second pair of tracks each configured to extend around a rearward sprocket, a forward sprocket, and a forward idler sprocket. Wheels, each attachable to and removable from a shaft, may also be supplied and used. A pair of rearward track extenders each removeably attachable to the chassis and each including a rearward idler sprocket may also be supplied and used along with a third pair of tracks each configured to extend around a rearward idler sprocket, a rearward sprocket, a forward sprocket, and a forward idler sprocket.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic three-dimensional front view showing an example of a robot in accordance with the subject invention in a wheeled configuration;

FIG. 2 is a schematic three-dimensional front view showing the robot of FIG. 1 with tracks in an “off-road” configuration;

FIG. 3 is a schematic three-dimensional front view of the robot shown in FIGS. 1 and 2 with front track extenders installed in a “curb-climb” configuration;

FIG. 4 is a schematic three-dimensional side view of the robot shown in FIGS. 1-3 with both front and rear track extenders installed in a “stair-climb” configuration;

FIG. 5 is a schematic three-dimensional view showing the primary components associated with installing a wheel on a drive shaft in accordance with the subject invention;

FIGS. 6A-6F are schematic three-dimensional views depicting the primary steps associated with installing wheels on the drive shafts on the robot of FIG. 1;

FIGS. 7A-7F are schematic three-dimensional side views showing the primary steps associated with installing track extender adapters on the robot chassis of FIG. 1 in accordance with the subject invention;

FIGS. 8A-8P are schematic three-dimensional views showing the primary steps associated with installing sprockets on the robot chassis;

FIGS. 9A-9L are schematic three-dimensional views showing the primary steps associated with installing front track extenders on the robot chassis;

FIGS. 10A-10J are schematic three-dimensional views showing the primary steps associated with installing both front and rear track extenders on the robot chassis; and

FIGS. 11-12 are schematic side views of a track extender in accordance with the subject invention with an integral track tensioning mechanism.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

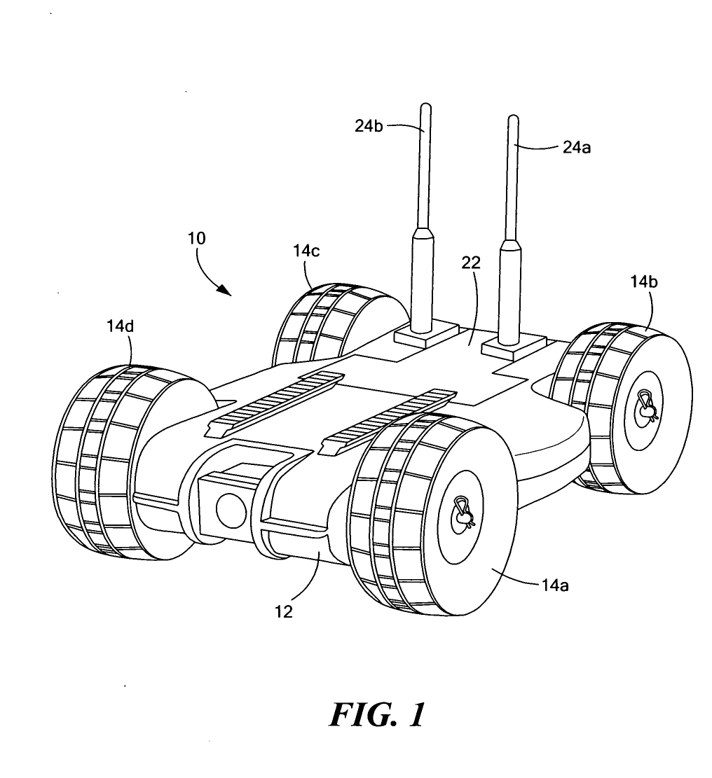

FIG. 1 shows a modified version of a prior art “Dragon Runner” robot 10 with chassis 12, four wheels 14a-14d, camera 18, digital radio 22 (for radio control of the robot), and antennas 24a and 24b. Other subsystems for the robot are possible including a turret and arm assembly and the like. See U.S. patent application Ser. No. 12/317,131 filed Dec. 18, 2008 and U.S. patent application Ser. No. 12/288,943 filed on Oct. 24, 2008 incorporated herein by this reference.

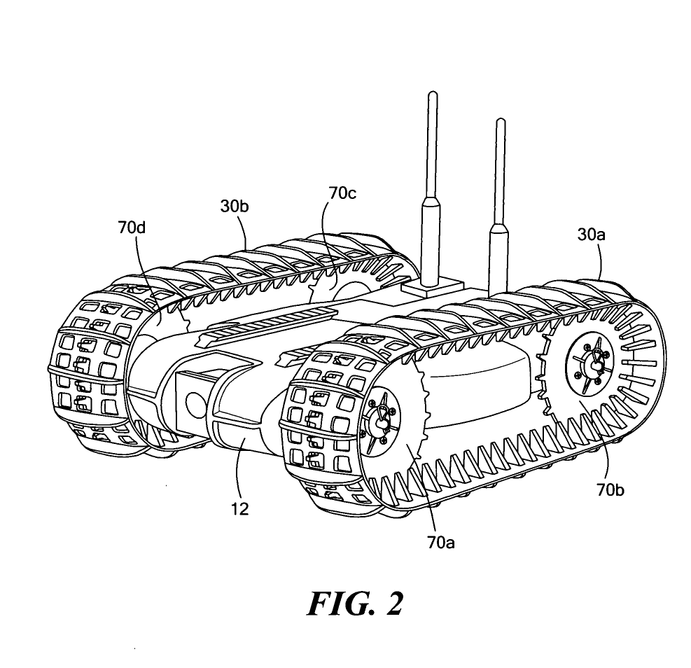

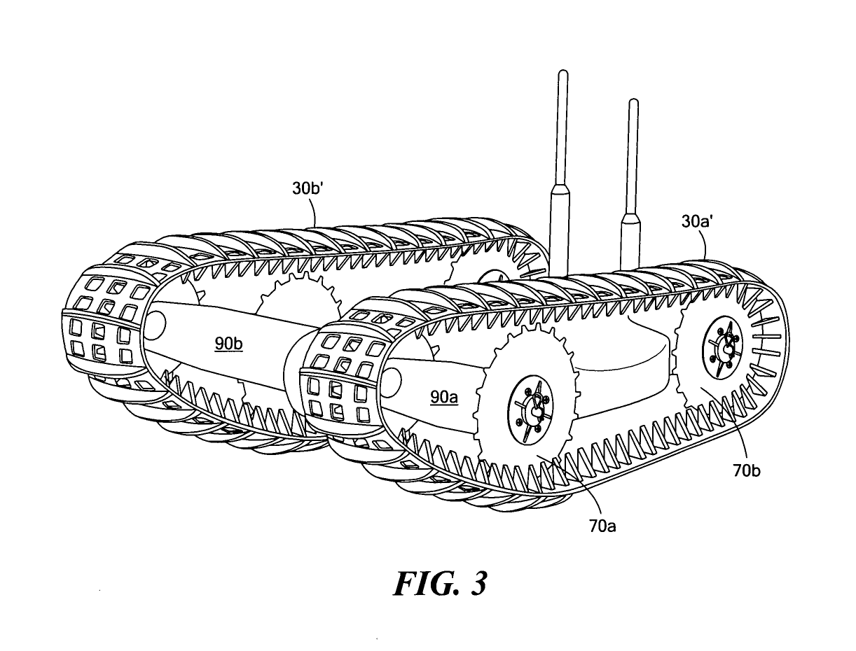

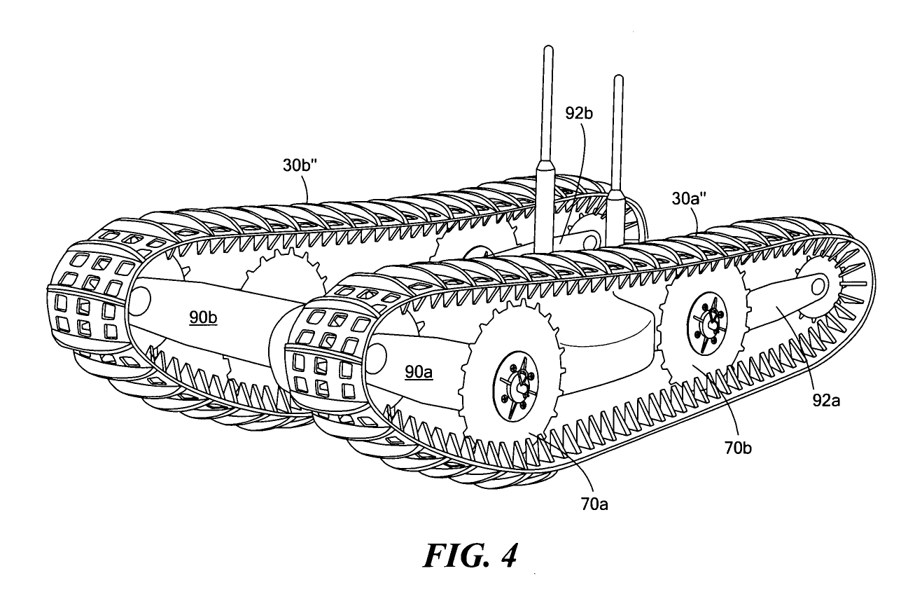

In accordance with the preferred embodiment of the subject invention, wheels 14a-14d are all driven and yet easily attached to and removable from their respective drive shafts. When the wheels are removed, sprockets 70a-70d can be added resulting in the robot shown in FIG. 2 with tracks 30a and 30b. When front track extenders 90a-90b are added together with longer tracks 30a′ and 30b′, FIG. 3, the result is a robot better able to traverse curbs and other obstacles. When rear track extenders 92a are added together with still longer tracks 30a ″ and 30b″, FIG. 4, the result is a robot better able to climb stairs and stair-like obstacles. Preferably all the wheels and sprockets are driven but in other designs only the rear or forward wheels may be driven. The subject invention also applies to vehicles with more than four shafts.

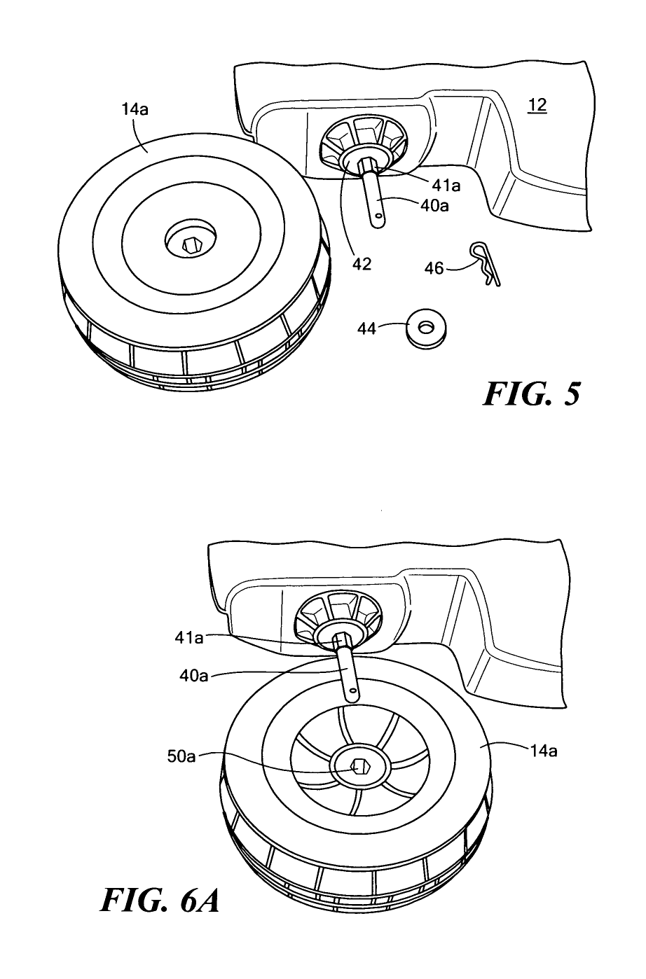

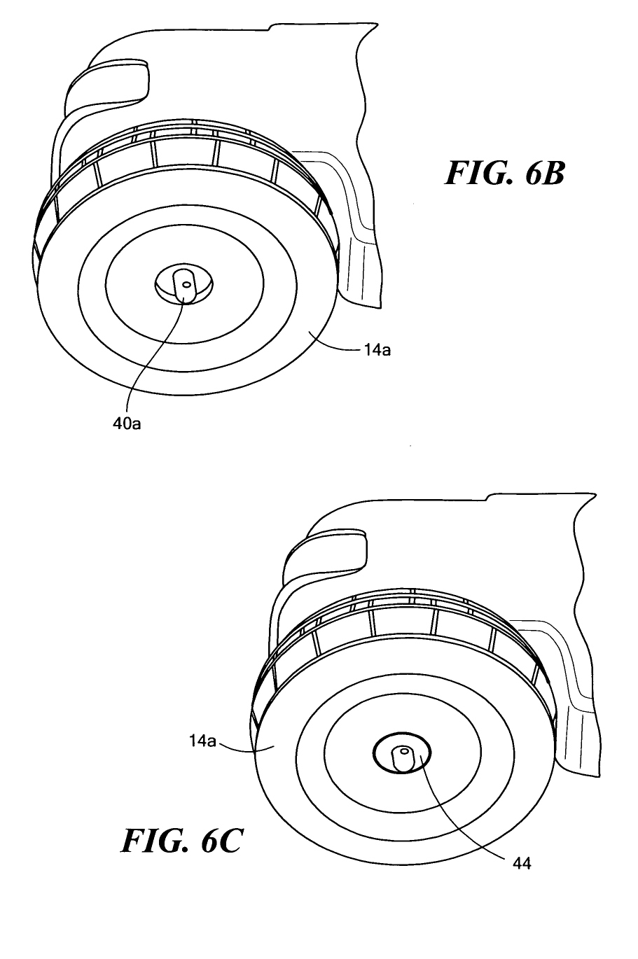

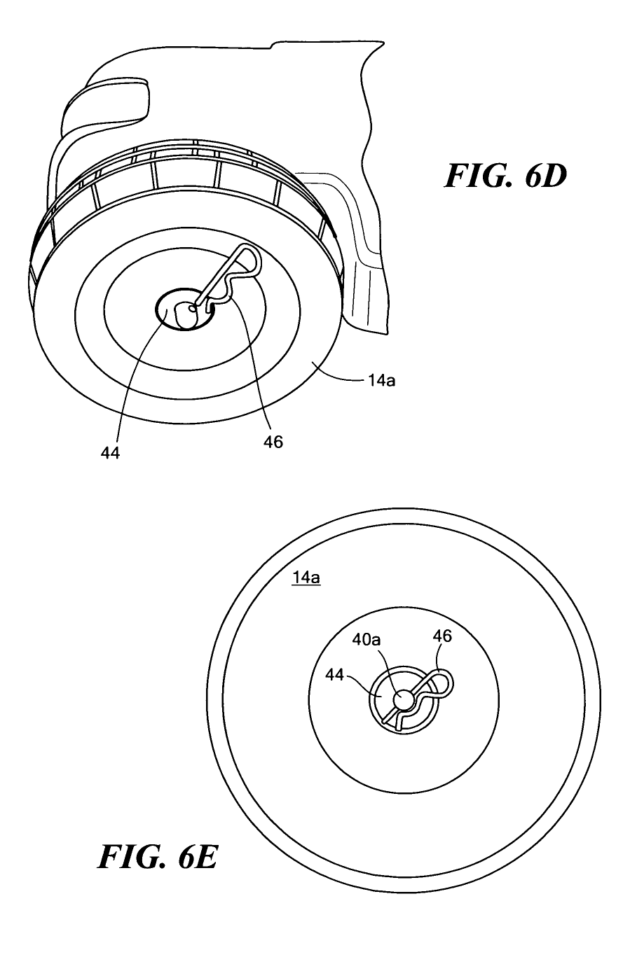

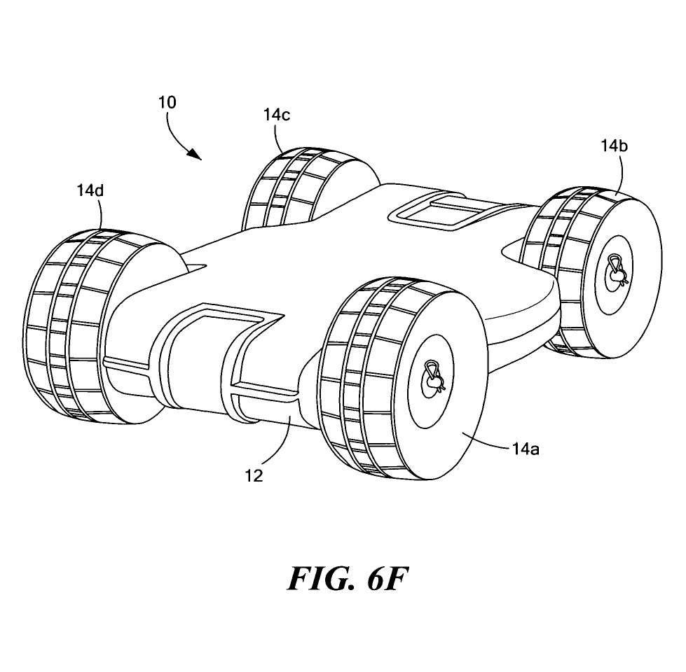

FIG. 5 shows one typically driven shaft 40a extending from chassis 12, wheel adapter 42 secured to chassis 12, wheel 14a, spacer 44, and clip 46. In FIG. 6A, hex-shaped driveshaft portion 41a is aligned with wheel hub hex opening 50. Other means for positively engaging the wheels on their respective drive shafts are possible. In FIG. 6B, wheel 14a is slid onto shaft 40a. In FIG. 6C, spacer 44 is slid onto the shaft and in FIG. 6D, clip 46 is aligned with and then inserted, FIG. 6E, into an orifice in hex shaft 40a. In a similar fashion, wheels 14b, 14c and 14d, FIG. 6F can be installed on robot chassis 12. Wheel removal involves performing these same steps in the reverse order. The result is wheels which are easy to install and remove without the use of tools.

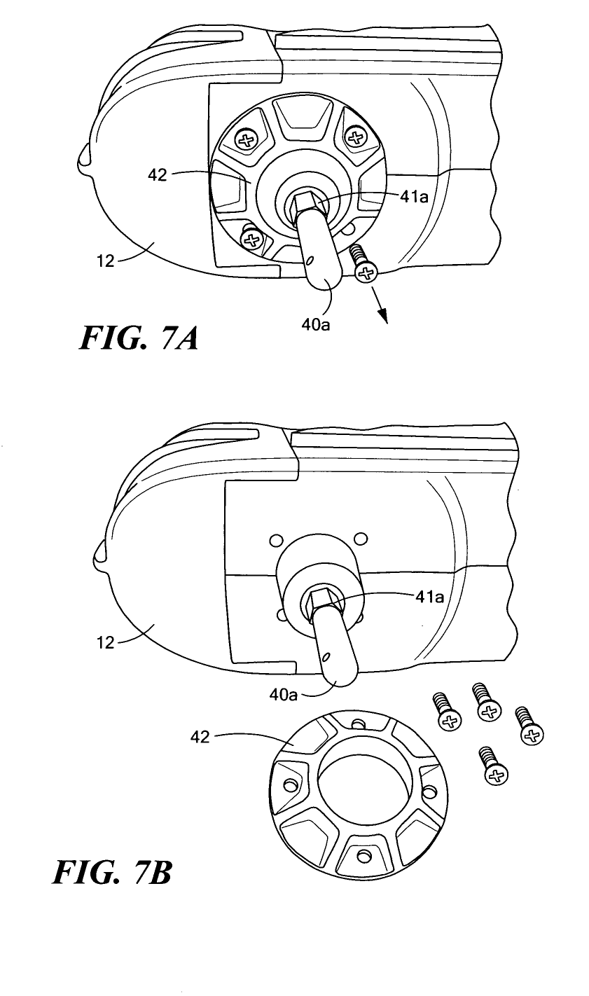

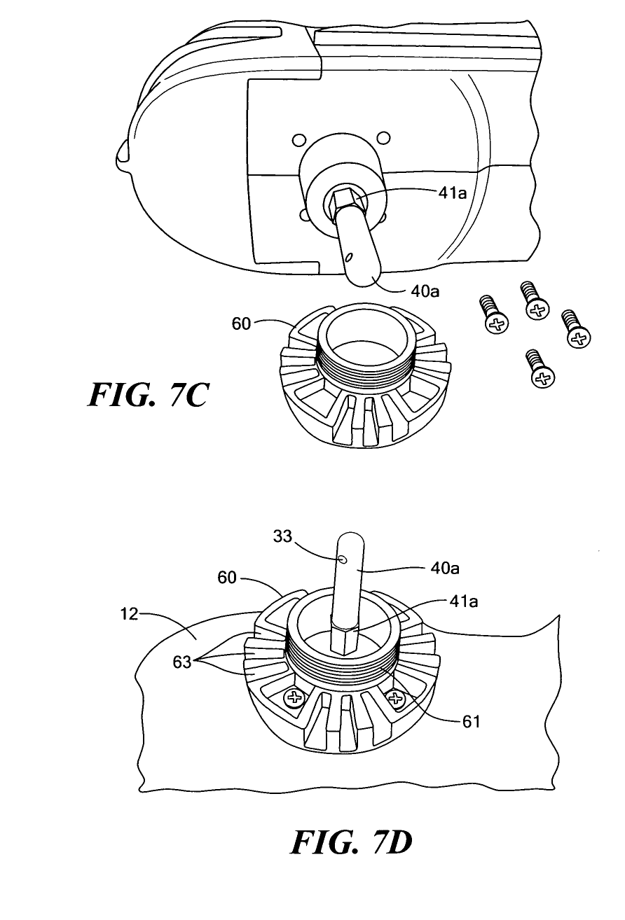

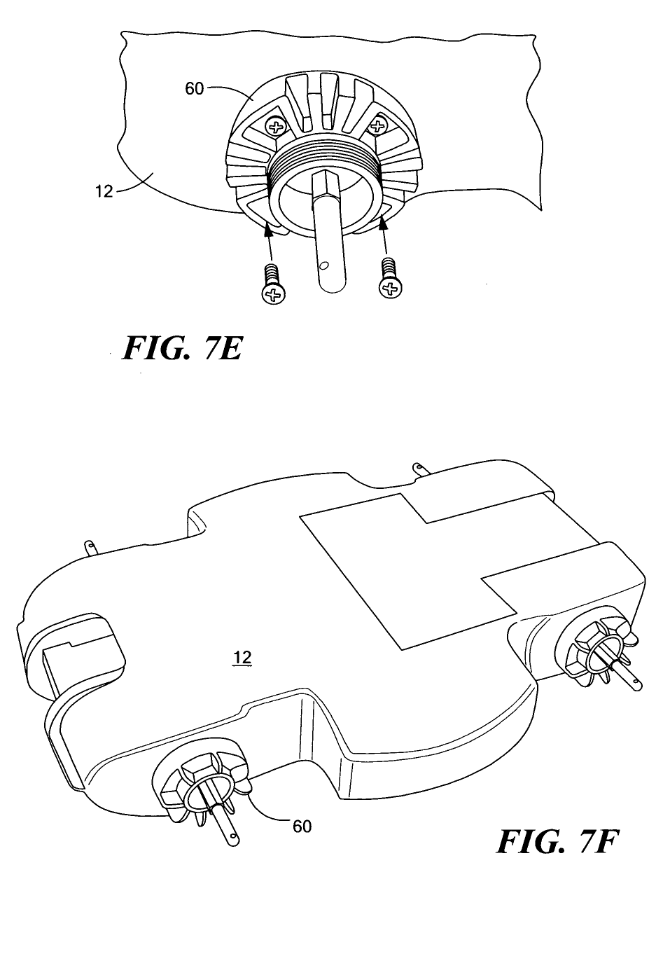

When tracks instead of wheels are desired, wheel adapter 42, FIG. 7A is removed as shown in FIG. 7B by removing the four screws securing wheel adapter 42 to chassis 12. In FIG. 7C, track hub adapter 60 with four screw holes is located and pushed onto the drive shaft and its screw holes are aligned with the screw holes in the chassis, FIG. 7D. FIG. 7D also shows hex portion 41 a of shaft 40a, threaded portion 61 of adapter 60, and orifice 33 in shaft 40a. Adapter 60 also includes features 63 used to positively lock a track extender in place at a desired angle. In FIG. 7E, the screws are inserted through track hub adapter 60 and tightened onto robot chassis 12. The same procedure is repeated for all the remaining axel hubs as shown in FIG. 7F. Note that the wheels also work with track hub adapter 60. Thus, one option is to have track hub adapter 60 always installed.

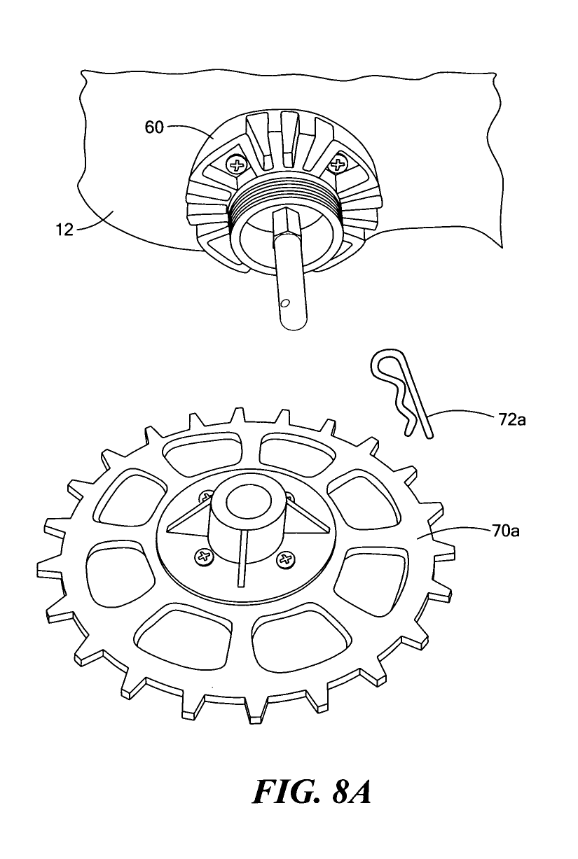

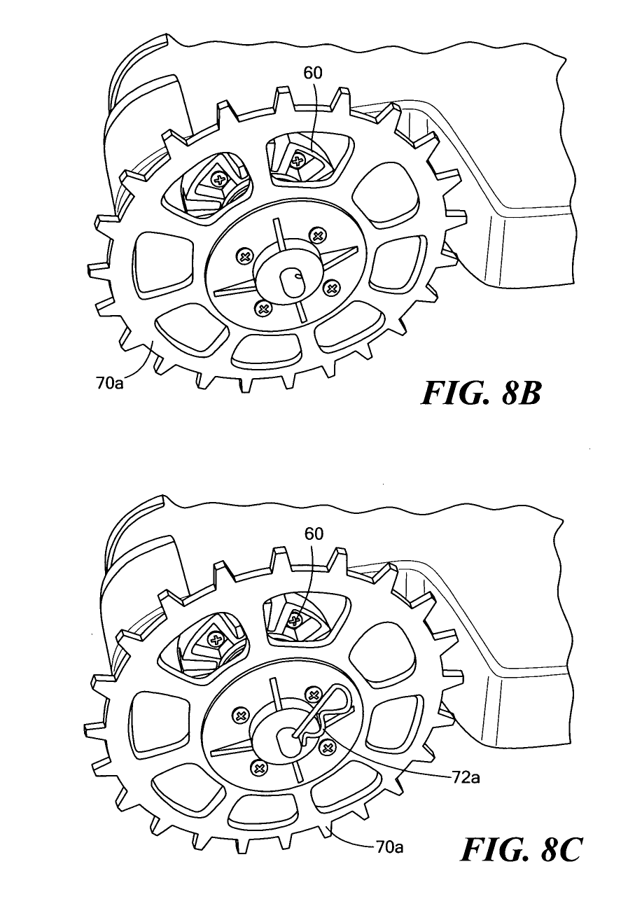

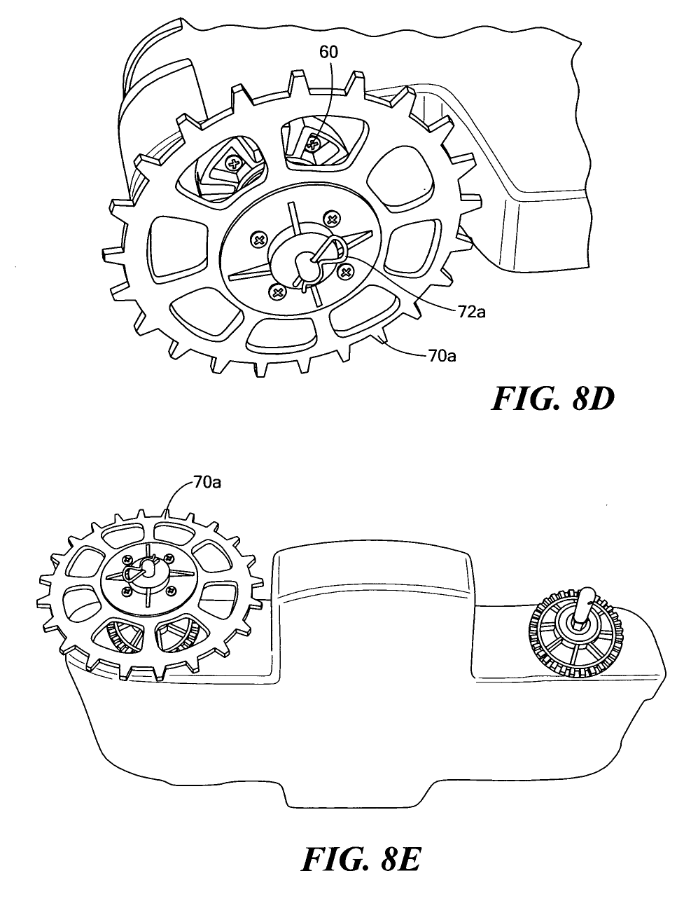

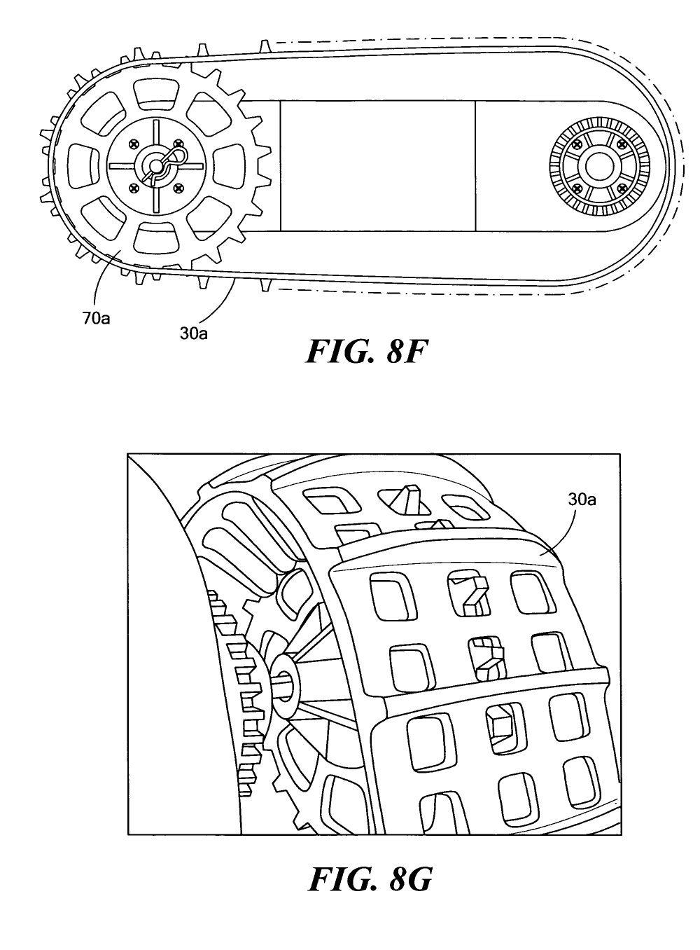

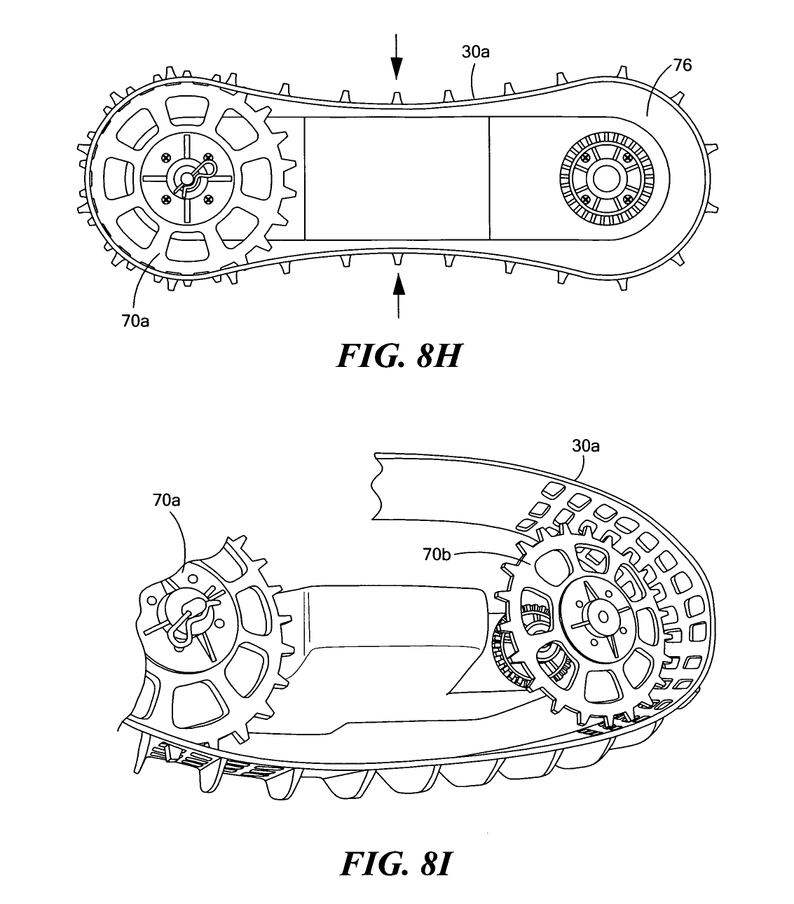

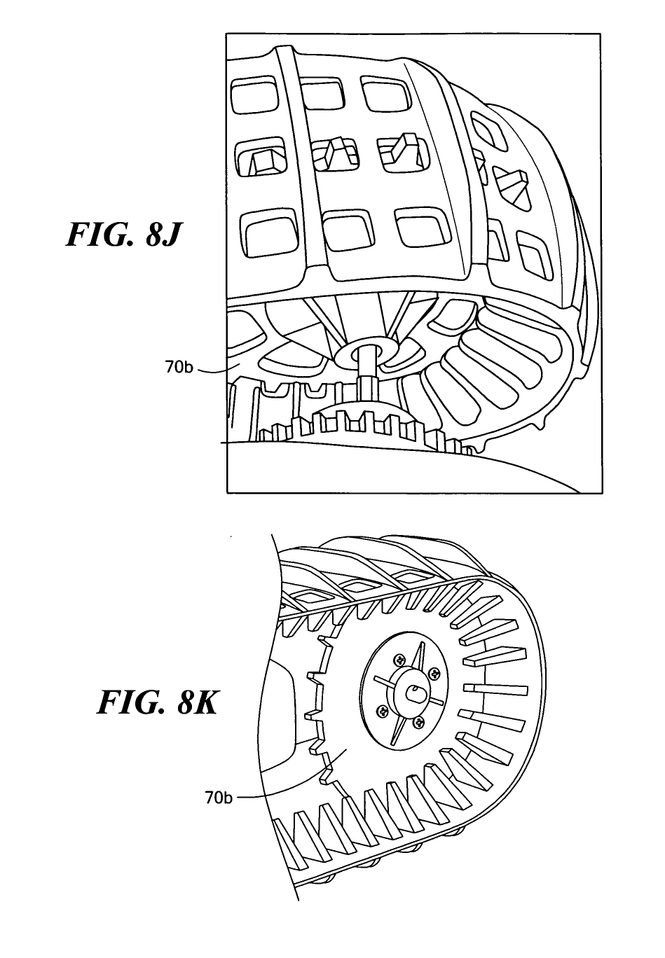

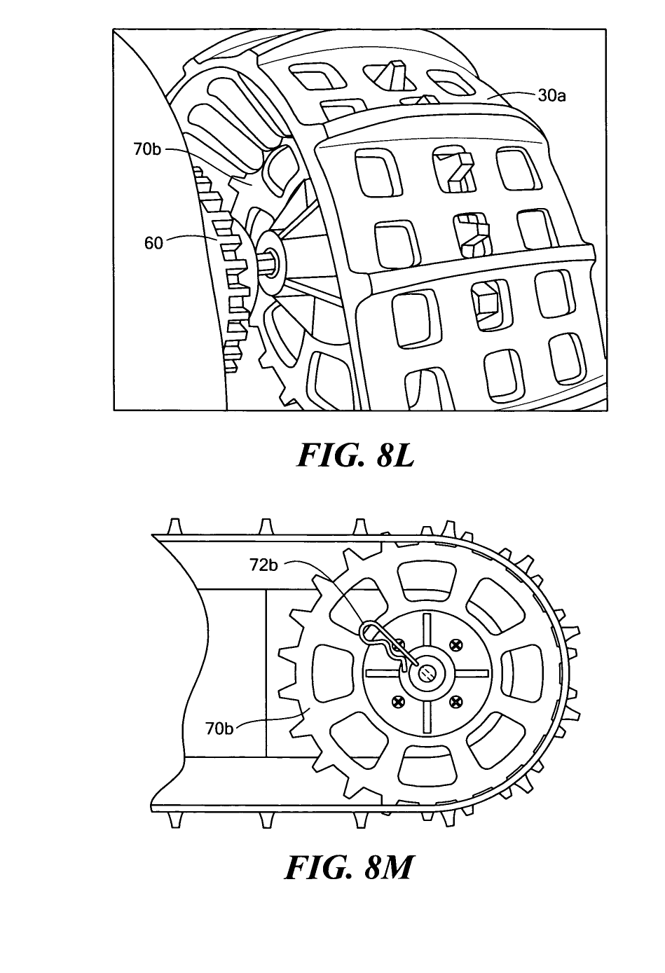

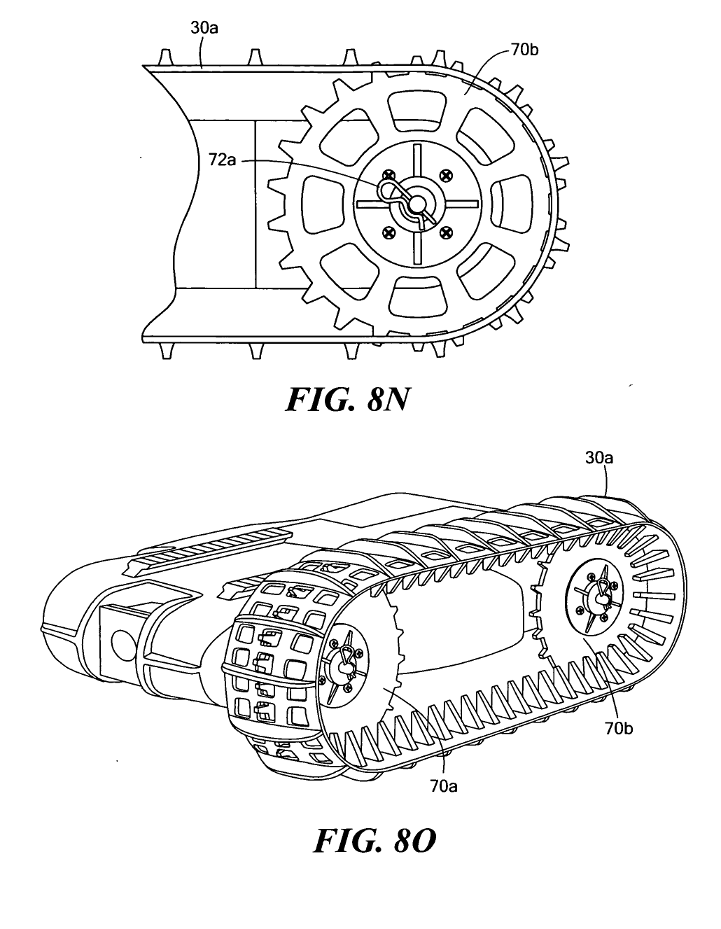

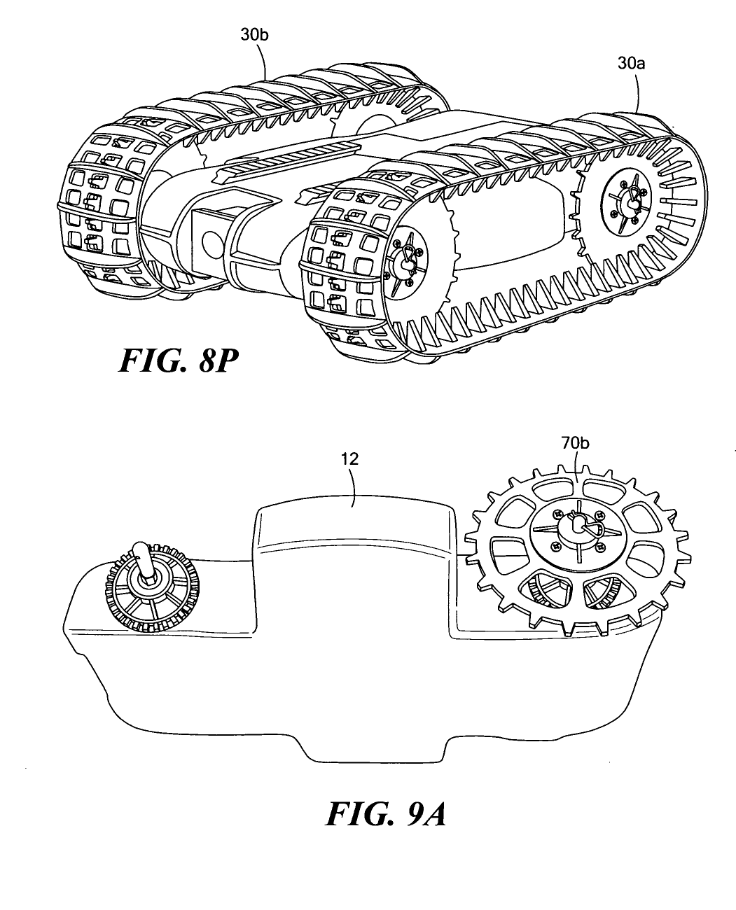

In FIG. 8A, sprocket 70a and clip 72a are located and then sprocket 70a, FIG. 8B is slid onto the drive shaft exposing the drive shaft hole. In FIG. 8C, pin clip 72a is aligned with the shaft hole and then pushed through the hole into the locked setting, FIG. 8D. In FIG. 8E, the vehicle is turned onto its side with sprocket 70a facing upwards. Track 30a, FIG. 8F is located and wrapped around sprocket 70a. In FIG. 8G, the sprocket teeth are engaged in the center of track tread 30a. In FIG. 8H, track 30a is pinched in the center to elongate it along the free shaft end 76 of the chassis. A second sprocket assembly 70b, FIG. 8I is then aligned with the center of track 30a and the sprocket teeth are engaged into the center tread holes between the tread guides. In FIG. 8J, the rear drive shaft is aligned with the sprocket 70b assembly hole and the sprocket is pushed onto the shaft and fully seated when the hole in the shaft is visible, FIG. 8K. The shaft may have to be adjusted or wiggled so that the hexagonal hole in the hub of the sprocket assembly lines up and fully seats onto the hexagonal drive shaft, FIG. 8L. In FIG. 8M, hair pin clip 72b is aligned with the hole in the drive shaft and pushed through the hole, FIG. 8N. Track 30a, FIG. 8O is now installed. By flipping the chassis onto the completed track side, the other track 30b can be installed in a similar fashion resulting in the configuration shown in FIG. 8P.

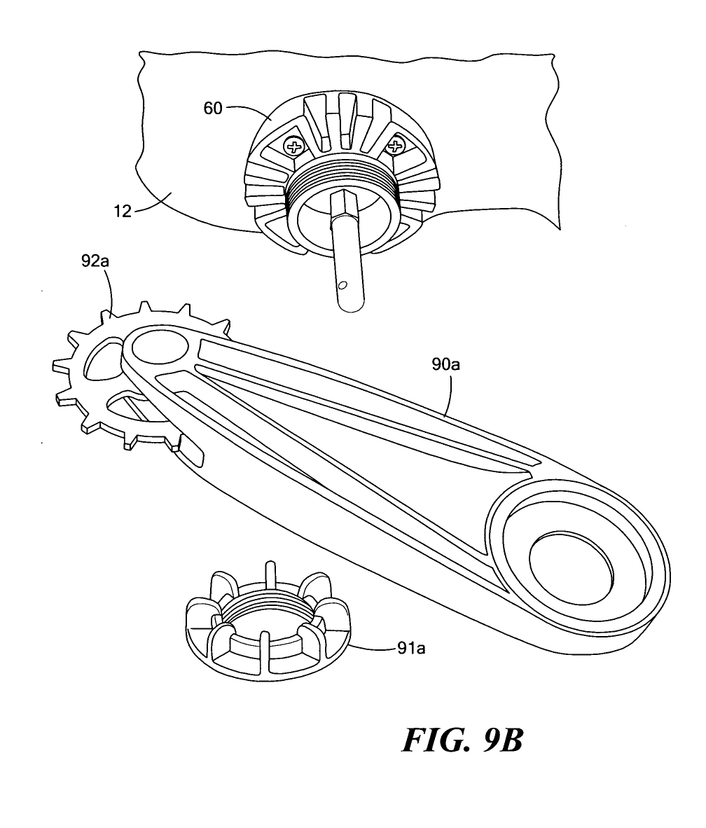

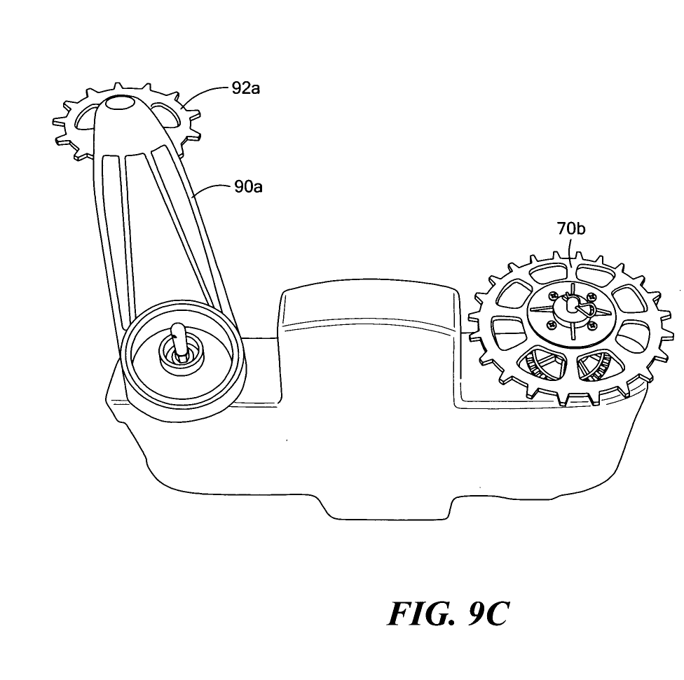

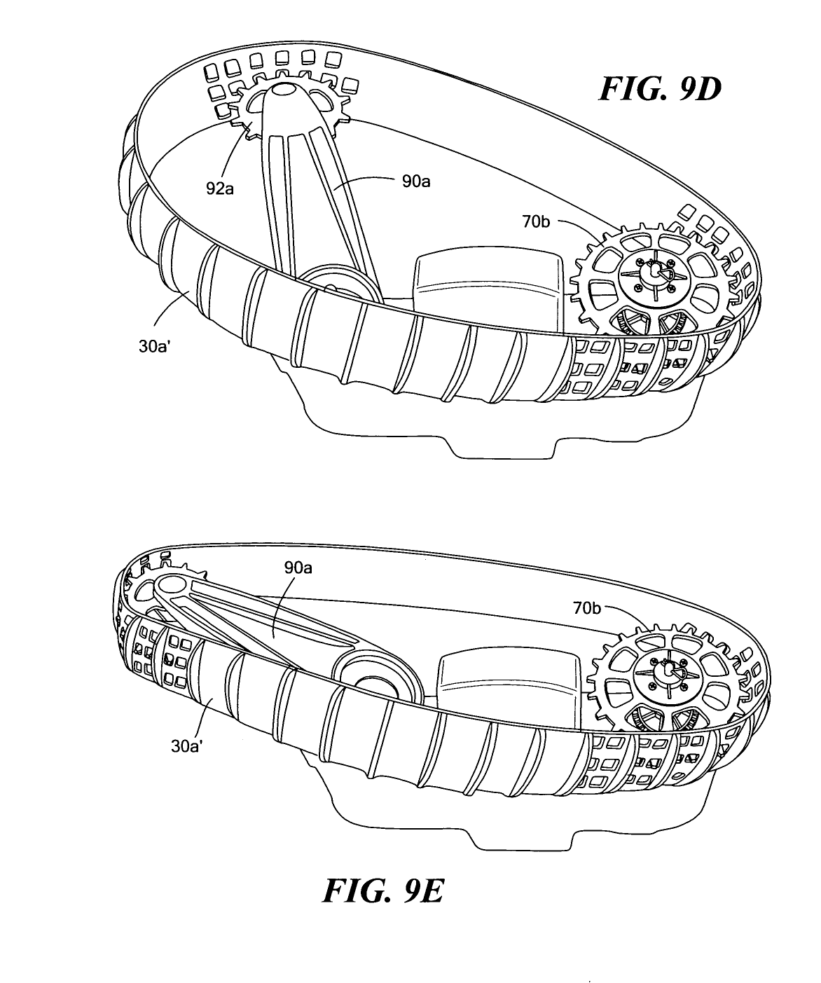

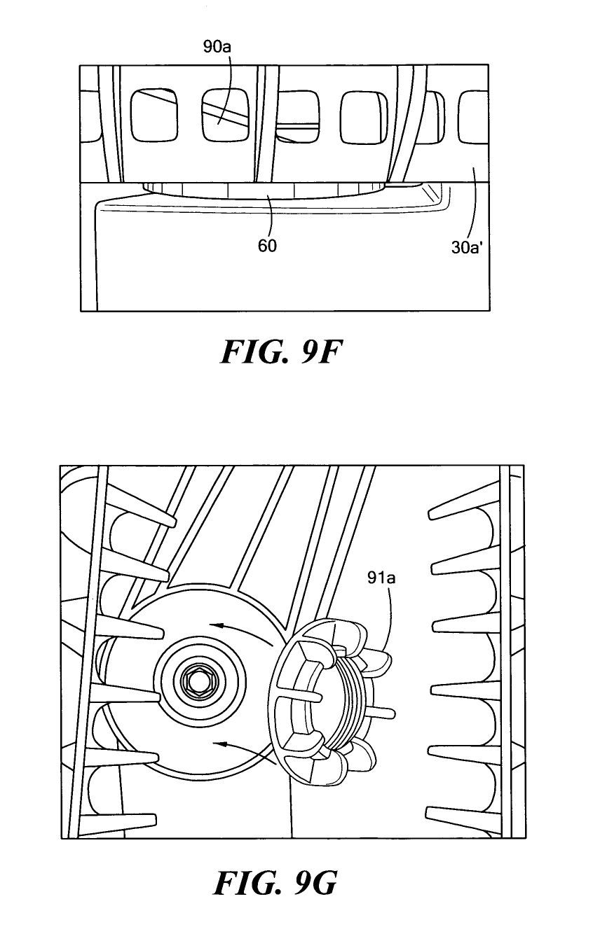

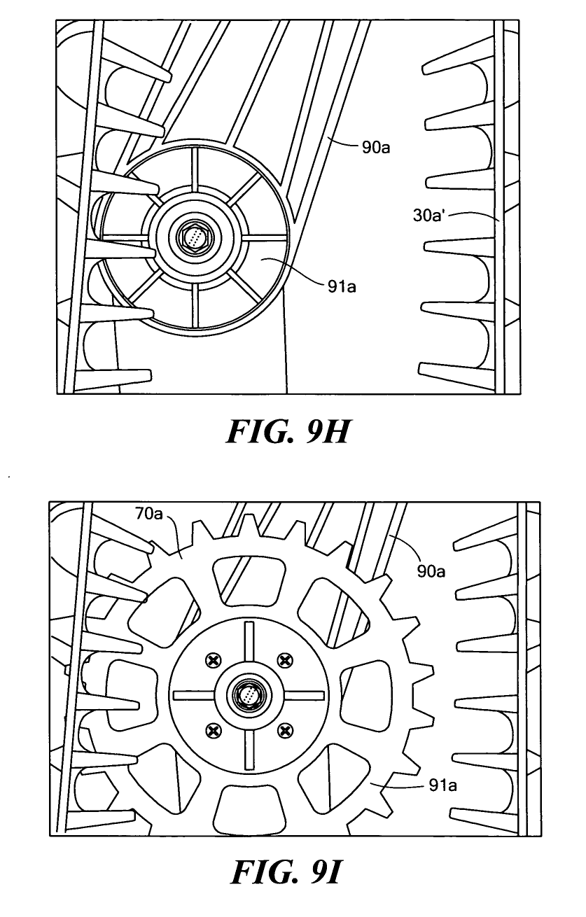

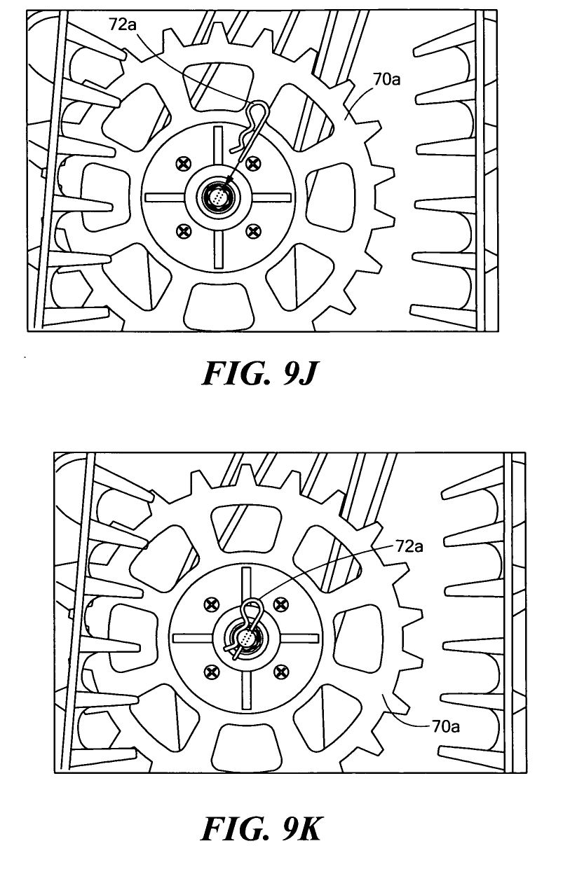

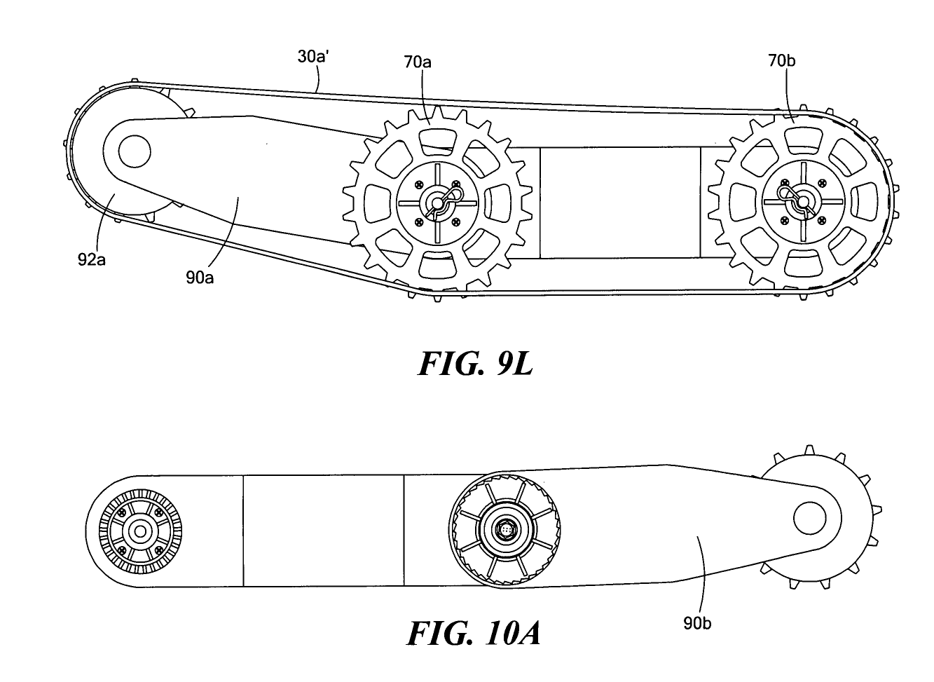

To install the front track extenders as shown in FIG. 3, rear sprocket 70b, FIG. 9A is installed and front track extender 90a with idler sprocket 92a is located, FIG. 9B. Extender 90a, FIG. 9C is slid over the hub and aligned at the steep angle shown. Track 30a′, FIG. 9D is slid over extender sprocket 92a and rear sprocket 70b. Again, the sprocket teeth should be aligned in the middle row of the tread holes and straddle the tread guides running along the inside center of the tread. In FIG. 9E, extender 90a is rotated towards the front to tighten track 30a′. Extender 90a is preferably aligned at an upward angle of 18° with respect to the horizontal as shown in FIG. 9E. In FIG. 9F, the extender is pressed fully onto the hub adapter allowing a protrusion/indentation on the hub adapter to fully mate and seat. The angle of extender 90a can be set by the user using the features 63, FIG. 7D on adapter 60 which mate with corresponding features on the extender. In FIG. 9G, a locking nut 91a is aligned and slipped over the threaded portion of the hub of the adapter. In FIG. 9H, the locking nut 91a is tightened fully against the extender securing it in place. In FIG. 9I, sprocket 70a is located and slid onto the front shaft again making sure the hex shaft is aligned and the sprocket is fully seated against the shaft revealing the shaft hole at the end of the shaft. Clip 72a, FIG. 9J is installed as shown in FIG. 9K. In FIG. 9L, track 30a′ is fully installed about sprockets 70b, 70a, and idler 92a of extender 90a. The same operation is performed on the other side of the robot resulting in the curb track configuration shown in FIG. 3. The track extenders can be angled upwardly or downwardly as desired.

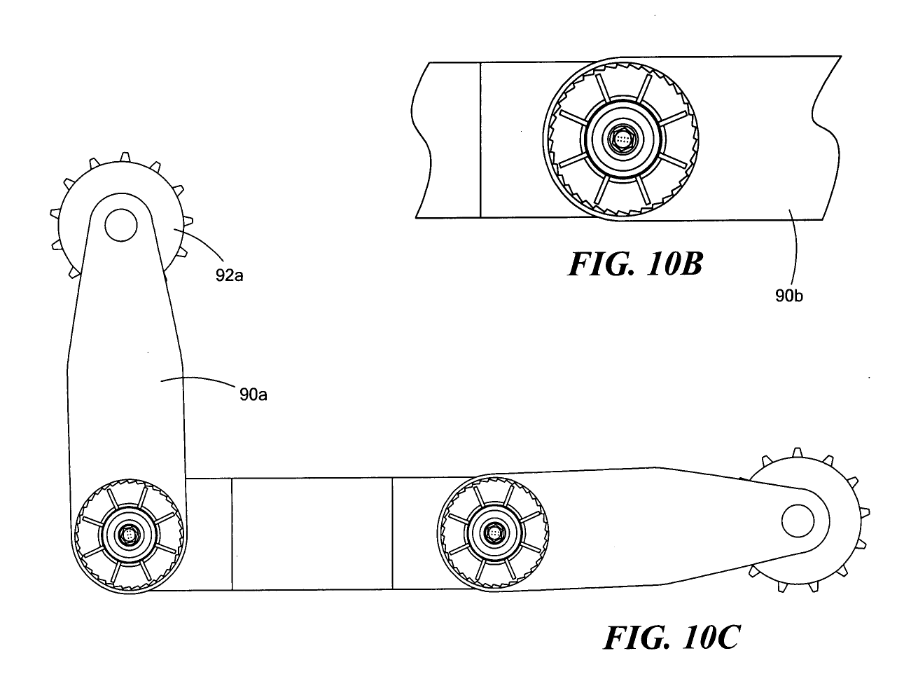

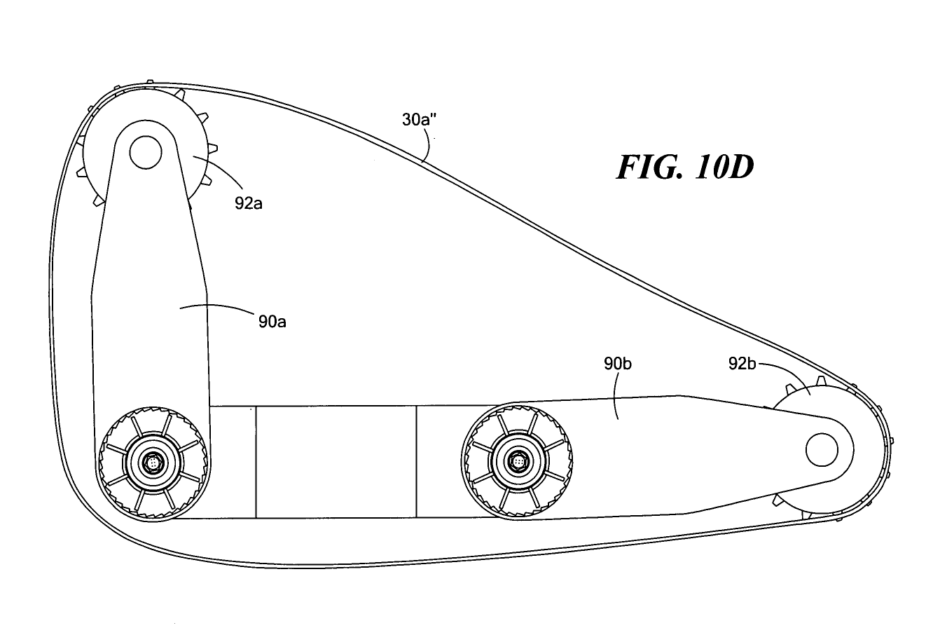

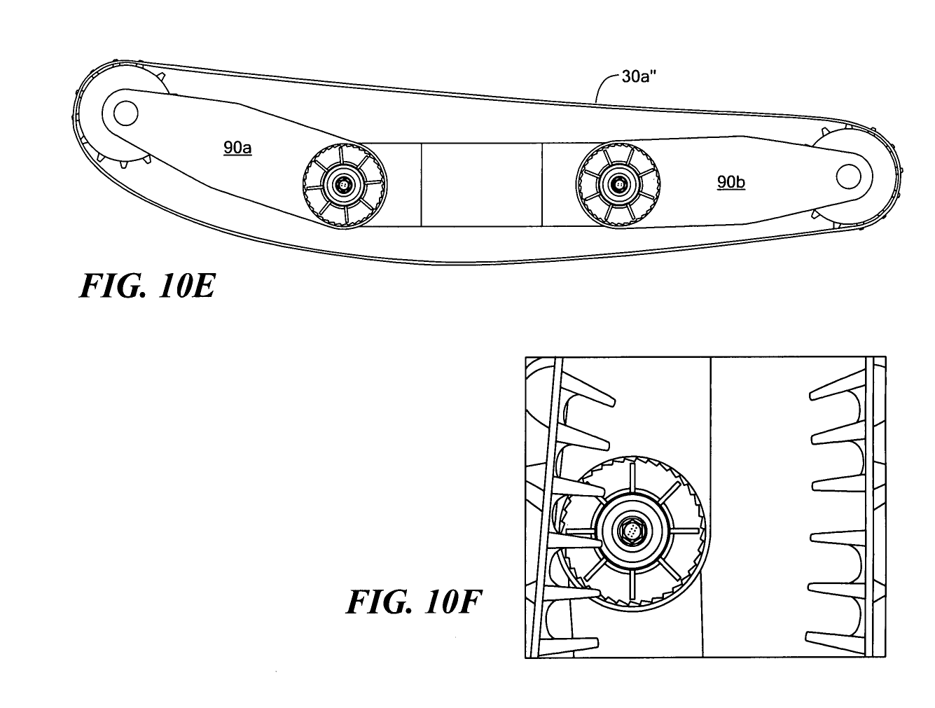

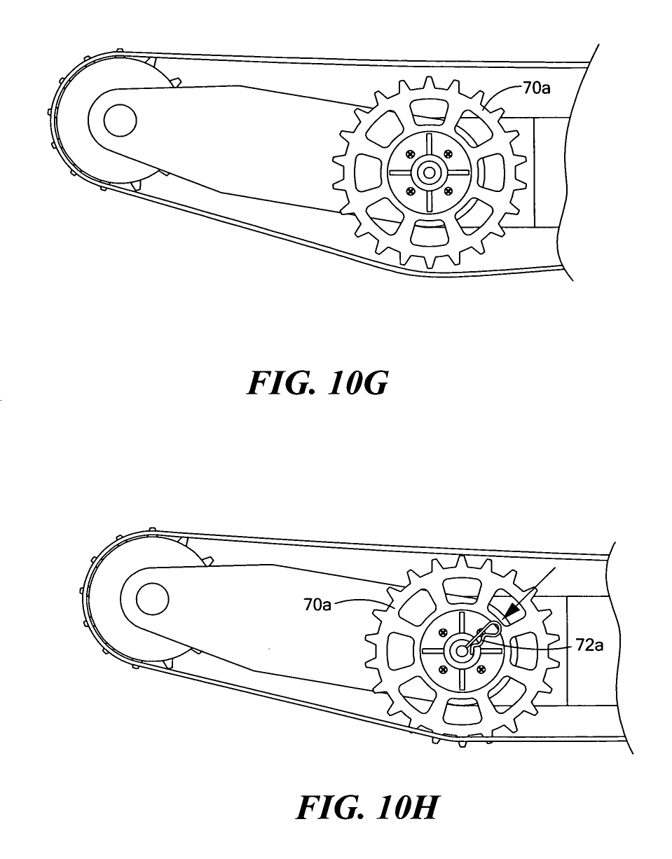

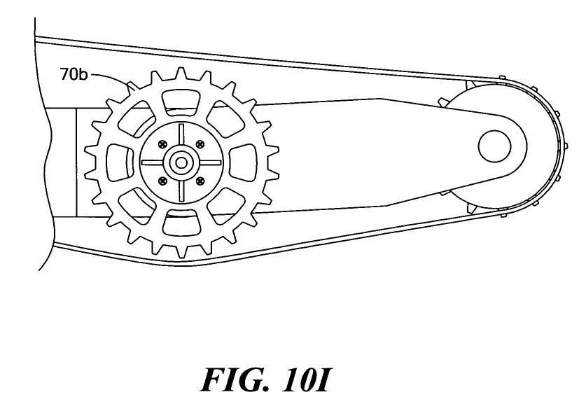

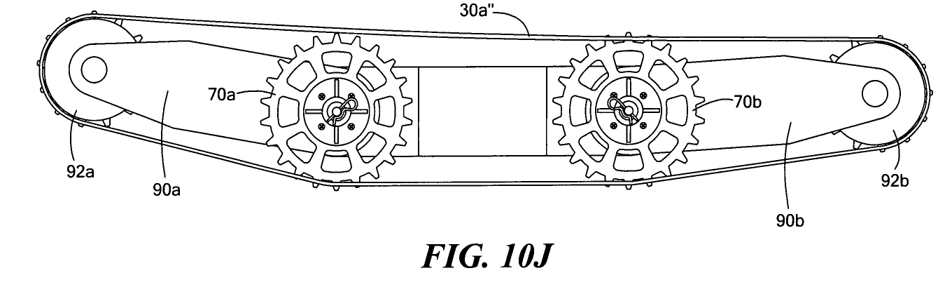

To configure the robot as shown in FIG. 4 with both front and rear track extenders, rear extender 90b, FIG. 10A is located and slid over the rear hub aligning it at a flat angle as shown in FIG. 10B. Front extender 90a is located and slid over the hub aligning it at the steep angle shown in FIG. 10C. Stair climbing tread 30a″, FIG. 10D is positioned around the idler sprockets 92a and 92b of front extender 90a and rear extender 90b, respectively. Front extender 90a, FIG. 10E, is then rotated and aligned at an upward angle of 18° with respect to the horizontal as shown. Other angles for the front and rear track extenders are possible.

As before, each extender is pushed flush onto its respective hub adapter allowing a protrusion/indentation feature on the hub adapter to fully mate and seat. The locking nut is then aligned and slipped over the threaded portion of the hub adapter and finger tightened locking it against the extender securing it in place, FIG. 10F. In FIG. 10G, sprocket 70a is installed on the front shaft using retainer clip 72a, FIG. 10H. In FIG. 10I, rear sprocket 70b is installed also using a retainer clip as discussed above resulting in track 30a″, FIG. 10J now installed about idler gears 92a, 92b, and sprockets 70a and 70b. The other track on the other side of the robot is installed in a similar fashion resulting in the configuration shown in FIG. 4.

The result is a conversion system for easily converting a wheeled robot into a track driven robot in at least four possible configurations: the wheeled robot shown in FIG. 1, the track “off-road” configuration shown in FIG. 2, the track “curb-climb” configuration shown in FIG. 3, and the track “stair-climb” configuration shown in FIG. 4. A minimum number of parts are required, installation and removal of the wheels, the tracks, and track sprockets, and the track extenders is simple and can be accomplished, if necessary, in the field and with no tools. Reliability is enhanced, especially for the stair climbing configuration depicted in FIG. 4, via a preferred all wheel drive robot since de-treading on reduced wrap-angled tread drives is minimized. Thus, all the wheels and all the drive sprockets in the preferred embodiment are driven.

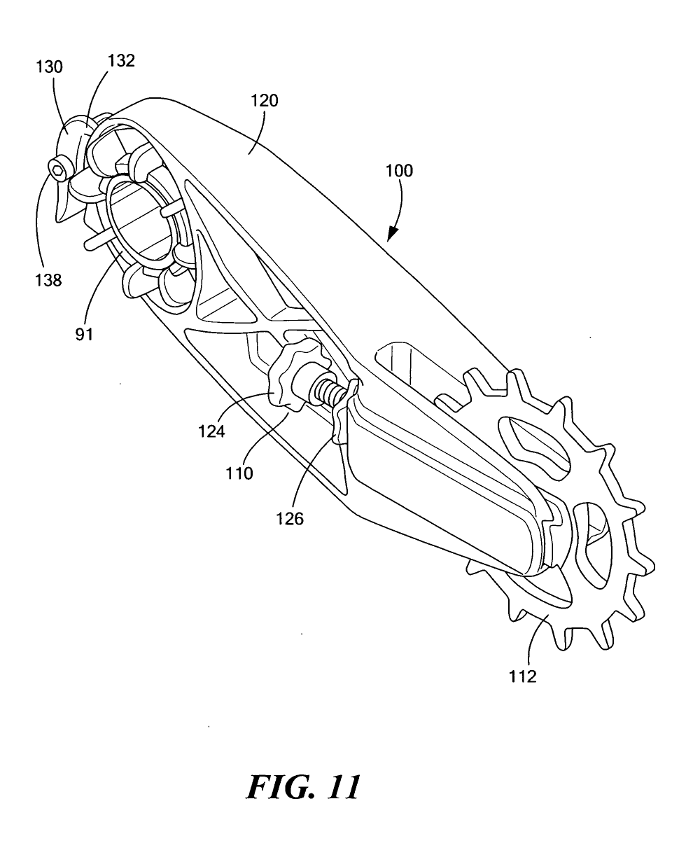

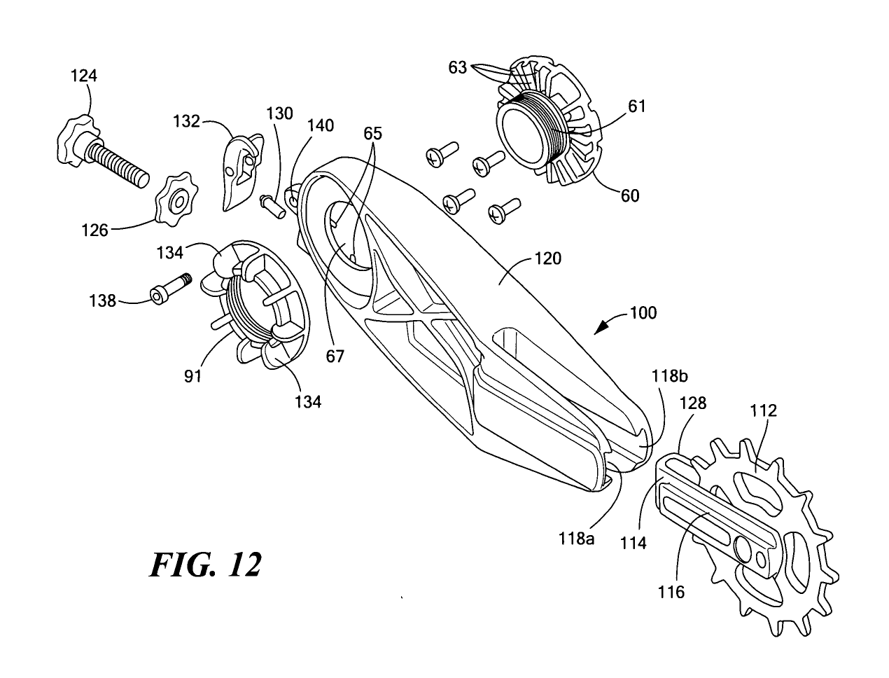

FIGS. 11-12 depict a track extender 100 with tensioning mechanism 110. Idler sprocket 112 is rotatably housed by slider 114 with opposing shoes (e.g., shoe 116) which slide in tracks 118a and 118b of paddle 120. Screw 124 with jam nut 126 threaded thereon is threaded into the body of paddle 120 until the distal end of screw 124 abuts against plate 128 of slider 114. By adjusting the screw 124, slider 114 is thus extended and retracted relative to paddle 120 to tension or loosen the track. Jam nut 126 retains screw 124 in the desired position. Also featured is lock member 130 with pawl 132 biased over a rib 134 of lock nut 91 via spring plunger 136 to prevent lock nut 91 from turning once installed. Shoulder screw 138 retains lock member 130 to ear 140 extending from paddle 120. For the rear track extenders, slider 114 is typically longer. FIG. 12 also shows how features 63 on adapter 60 can interlock with corresponding features 65 on the inside of paddle 120 about orifice 67 to lock the angle of paddle 120 relative to the horizontal. FIG. 12 also more clearly shows female threads of lock nut 91 which mate with male threads 61 of adapter 60.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A reconfigurable robot comprising:
a chassis with at least a pair of forward shafts and a pair of rearward shafts;
a wheel attachable to and removable from each forward shaft;
a wheel attachable to and removable from each rearward shaft;
a forward sprocket attachable to and removable from each forward shaft;
a rearward sprocket attachable to and removable from each rearward shaft;
a first pair of tracks each configured to extend around a forward sprocket and a rearward sprocket;
a pair of forward track extenders each removeably attachable to the chassis and each including a forward idler sprocket;
a second pair of tracks each configured to extend around a rearward sprocket, a forward sprocket, and a forward idler sprocket;
a pair of rearward track extenders each removeably attachable to the chassis and each including a rearward idler sprocket; and
a third pair of tracks each configured to extend around a rearward idler sprocket, a rearward sprocket, a forward sprocket, and a forward idler sprocket.

2. The robot of claim 1 further including a forward pair of removable sprocket adapters and a rearward pair of removable sprocket adapters.

3. The robot of claim 2 in which sprocket adapters include male members and the track extenders include corresponding female members for locking the angle of the track extenders.

4. The robot of claim 3 in which each sprocket adapter includes a threaded portion and the robot further including a threaded nut securing a track extender to the threaded portion of the sprocket adapter.

5. The robot of claim 1 in which the forward track extenders extend at an angle upwardly or downwardly from the chassis.

6. The robot of claim 1 in which the forward and rearward track extenders extend substantially beyond the robot chassis.

7. The robot of claim 1 in which the extenders include a track tensioning mechanism.

8. The robot of claim 1 in which the forward and rearward drive shafts are driven.

9. The robot of claim 1 further including means for removeably locking a wheel and a sprocket with respect to a drive shaft.

10. The robot of claim 9 in which said means includes an orifice through the shaft, a clip secured through the orifice, a hex portion on the drive shaft, and a hex orifice in the wheels and sprockets.

11. A reconfigurable robot comprising:
a chassis with at least a pair of forward shafts and a pair of rearward shafts;
a wheel attachable to and removable from each forward shaft;
a wheel attachable to and removable from each rearward shaft;
a forward sprocket attachable to and removable from each forward shaft;
a rearward sprocket attachable to and removable from each rearward shaft; and
a first pair of tracks each configured to extend around a forward sprocket and a rearward sprocket.

12. The robot of claim 11 further including a pair of forward track extenders each removeably attachable to the chassis and each including a forward idler sprocket.

13. The robot of claim 12 further including a second pair of tracks each configured to extend around a rearward sprocket, a forward sprocket, and a forward idler sprocket.

14. The robot of claim 11 further including a pair of rearward track extenders each removeably attachable to the chassis and each including a rearward idler sprocket.

15. The robot of claim 14 further including a third pair of tracks each configured to extend around a rearward idler sprocket, a rearward sprocket, a forward sprocket, and a forward idler sprocket.

16. A reconfigurable robot comprising:
a chassis with at least a pair of forward shafts and a pair of rearward shafts;
a forward sprocket attachable to and removable from each forward shaft;
a rearward sprocket attachable to and removable from each rearward shaft;
a first pair of tracks each configured to extend around a forward sprocket and a rearward sprocket;
a pair of forward track extenders each removeably attachable to the chassis and each including a forward idler sprocket; and
a second pair of tracks each configured to extend around a rearward sprocket, a forward sprocket, and a forward idler sprocket.

17. The reconfigurable robot of claim 16 further including a wheel attachable to and removable from each shaft.

18. The robot of claim 16 further including a pair of rearward track extenders each removeably attachable to the chassis and each including a rearward idler sprocket.

19. The robot of claim 18 further including a third pair of tracks each configured to extend around a rearward idler sprocket, a rearward sprocket, a forward sprocket, and a forward idler sprocket.

20. A reconfigurable robot comprising:
a chassis with at least a pair of forward shafts and a pair of rearward shafts;
a forward sprocket attachable to and removable from each forward shaft;
a rearward sprocket attachable to and removable from each rearward shaft;
a first pair of tracks each configured to extend around a forward and a rearward sprocket;
a pair of forward track extenders each removeably attachable to the chassis and each including a forward idler sprocket;
a pair of rearward track extenders each removeably attachable to the chassis and each including a rearward idler sprocket; and
a second pair of tracks each configured to extend around a rearward idler sprocket, a rearward sprocket, a forward sprocket, and a forward idler sprocket.

21. The robot of claim 20 further including a wheel attachable to and removable from each shaft.

22. The robot of claim 20 further including a third pair of tracks each configured to extend around a rearward sprocket, a forward sprocket, and a forward idler sprocket.

23. A reconfigurable robot comprising:
a chassis with at least a pair of forward shafts and a pair of rearward shafts;
a forward sprocket attachable to and removable from each forward shaft;
a rearward sprocket is attachable to and removable from each rearward shaft;
a pair of forward track extenders each removeably attachable to the chassis and each including a forward idler sprocket; and
a pair of tracks each configured to extend around a rearward sprocket, a forward sprocket, and a forward idler sprocket.

24. The robot of claim 23 further including a wheel attachable to and removable from each shaft.

25. A reconfigurable robot comprising:
a chassis with at least a pair of forward shafts and a pair of rearward shafts;
a forward sprocket attachable to and removable from each forward drive shaft;
a rearward sprocket attachable to and removable from each rearward shaft;
a pair of forward track extenders each removeably attachable to the chassis and each including a forward idler sprocket;
a pair of rearward track extenders each removeably attachable to the chassis and each including a rearward idler sprocket; and
a pair of tracks each configured to extend around a rearward idler sprocket, a rearward sprocket, a forward sprocket, and a forward idler sprocket.

26. The robot of claim 25 further including a wheel attachable to and removable from each shaft.
